(19) United States
(12) Patent Application Publication
(10) Pub. No.: US 2018/0072337 A1
(43) Pub. Date: Mar. 15, 2018

(54) WASTE RECEPTACLE DOLLIES AND ANCHORS

(71) Applicant: Rubbermaid Commercial Products LLC, Atlanta, GA (US)

(72) Inventors: Ralph Strayhorn, Charlotte, NC (US); Mike Gregory, Huntersville, NC (US); Marcel Arantes Souza, Kalamazoo, MI (US); Zachary Hafner, Kalamazoo, MI (US); William T. Oltman, Grand Rapids, MI (US); Michael Paul Dawson, Huntersville, NC (US); David Engvall, Stanley, NC (US)

(21) Appl. No.: 15/699,870

(22) Filed: Sep. 8, 2017

Related U.S. Application Data
(60) Provisional application No. 62/385,449, filed on Sep. 9, 2016.

(51) Int. Cl. B62B 5/00; B65F 1/14; B65F 1/16; B65D 90/12

(52) U.S. Cl. CPC B62B 5/0083; B65F 1/141; B65F 1/122; B65D 90/12; B65F 1/1615

(57) ABSTRACT

Dollies and anchors for securing the movement of waste receptacles are provided. A dolly includes a dolly base configured to securely receive an enclosed base portion of a waste receptacle. The waste receptacle has at least one sidewall extending from the enclosed base portion to define an open top portion. The open top portion is defined by a rim and configured to receive waste material therethrough. The dolly base is coupled with at least two wheels and at least one elongated shaft. At least one elongated shaft extends in a direction substantially traverse to the dolly base.

### CROSS-REFERENCE TO RELATED APPLICATIONS

This application claims priority benefit of U.S. Provisional Application No. 62/385,449, filed on Sep. 9, 2016, which is incorporated by reference herein in its entirety.

### BACKGROUND

The present disclosure relates generally to waste receptacle accessories, and relates more particularly to dollies and anchors for waste receptacles.

Consumers use waste receptacles in a variety of high volume applications, and rugged or harsh environments and terrains. For example, waste receptacles are often used in outdoor applications where conditions make securing and/or transporting receptacles difficult. Limited options for transporting and/or securing receptacles currently exist. Thus, there is a need for improved accessories for transporting and securing waste receptacles.

### SUMMARY

In one aspect, a dolly for a waste receptacle is provided, including a dolly base configured to securely receive an enclosed base portion of a waste receptacle that has at least one sidewall extending from the enclosed base portion to define an open top portion configured to receive waste material therethrough. The open top portion is defined by a rim. The dolly for a waste receptacle includes at least two wheels coupled to the dolly base and at least one elongated shaft coupled to the dolly base. At least one elongated shaft extends in a direction substantially transverse to the dolly base and at least one handle is coupled to the shaft.

In another aspect, an anchor for a waste receptacle includes an anchor base configured to securely receive an enclosed base portion of a waste receptacle that has at least one sidewall extending form the enclosed base portion to define an open top portion. The open top portion is configured to receive waste material therethrough. The anchor base includes at least one aperture arranged to securely receive an anchor pin. One or more projections extend from the anchor base and are configured to mate with a corresponding groove of the enclosed base portion of the waste receptacle, such that the waste receptacle is secured thereto.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a perspective view of one embodiment of a waste receptacle.

FIG. 2 is a perspective view of a waste receptacle attached to one embodiment of a dolly.

FIG. 3 is a rear view of the dolly of FIG. 2 in use.

FIG. 4A is a perspective view of a waste receptacle attached to one embodiment of a dolly.

FIG. 4B is a side view of the waste receptacle attached to the dolly of FIG. 4A.

FIG. 4C is a rear view of the waste receptacle attached to the dolly of FIG. 4A.

FIG. 4D is a side view of the waste receptacle attached to the dolly of FIG. 4A.

FIG. 5 is a perspective view of one embodiment of a dolly.

FIG. 6A is a side view of the dolly of FIG. 5.

FIG. 6B is a magnified view of a portion of the dolly of FIG. 6A.

FIG. 7 is a side view of one embodiment of a waste receptacle dolly.

FIG. 8 is a rear view of one embodiment of a waste receptacle dolly.

FIG. 9 is a rear view of one embodiment of a waste receptacle dolly.

FIG. 10 is a magnified view of pull-pin insertion points on one embodiment of a dolly base.

FIG. 11 is a side view of one embodiment of a projection of a dolly base or anchor mating with a corresponding groove on a waste receptacle.

FIG. 12 is a perspective view of one embodiment of a waste receptacle dolly.

FIG. 13 is an exploded view of the waste receptacle dolly of FIG. 12.

FIG. 14A is a perspective view of a waste receptacle attached to an anchor.

FIG. 14B is a perspective view of one embodiment of a dolly for mating with the anchor of FIG. 14A.

FIG. 15 is an exploded view of one embodiment of a waste receptacle dolly.

FIG. 16A is a perspective view of one embodiment of a receptacle anchor.

FIG. 16B is a partial view of the receptacle anchor of FIG. 16A.

FIG. 16C is a perspective view of the receptacle anchor of FIG. 16A.

FIG. 17 is a perspective view of various embodiments of anchor pins.

### DETAILED DESCRIPTION

The present disclosure provides dollies and anchors for transporting and securing waste receptacles, respectively. For example, these accessories may be useful in outdoor and other high volume environments (e.g., industrial applications, construction applications, food service applications), as well as in situations where terrain is uneven and/or conditions are unstable (e.g., extreme weather conditions). For example, these accessories may be used to traverse and secure waste receptacles across various surfaces and terrains, including but not limited to dirt, gravel, grass, asphalt/pavement, carpet, curbs, inclines/declines, and thresholds.

Various waste receptacle designs are known in the art and may be used with the receptacle accessories described herein. For example, the waste receptacle may be an interior-style receptacle, an exterior-style receptacle, a larger format receptacle, a wheeled receptacle, or any other suitable receptacle. It should be appreciated that although the accessories disclosed herein are described and illustrated with reference to certain example waste receptacles, the dollies and anchors may be used with any suitable waste receptacles and are not meant to be limited by the waste receptacles disclosed and illustrated herein. For example, the waste receptacles may be 10-, 20-, 32-, 44-, 55-gallon, or other volume receptacles.

Waste Receptacles

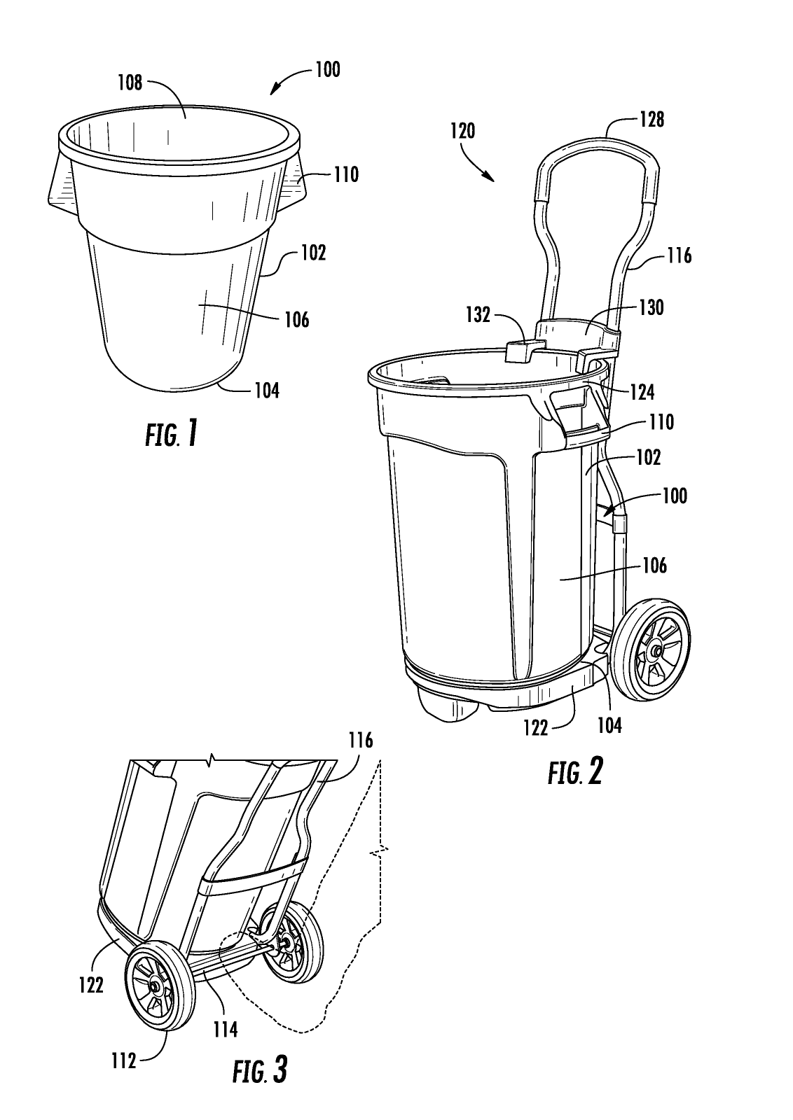

In certain example embodiments, as shown in FIG. 1, a waste receptacle 100 includes an enclosure 102 having an enclosed base portion 104 and at least one sidewall 106 extending from the base portion 104 to define an open top portion 108 to receive waste material therethrough. As used herein, the terms “enclosure” and “enclosed base portion” refer to the receptacle 100 having substantially continuous walls to contain the waste material; however, it should be appreciated that the walls may include certain openings, such as drains, vents, or other suitable openings.

In certain example embodiments, the at least one sidewall 106 includes a front wall, a rear wall, and two opposing sidewalls. In some embodiments, the sidewall(s) may include handle(s) 110 extending therefrom. For example, the handle(s) may be any suitable design known to those in the art.

In certain example embodiments, the enclosed base portion 104 forms the bottom of the waste receptacle 100. In certain example embodiments, the waste receptacle 100 also includes a lid that is hingedly and rotatably coupled to the enclosure. In certain example embodiments, the waste receptacle 100 also includes a pedal pivotably coupled to the base portion and pivotable from a first position to a second position. For example, the first position may be an unactuated or “at rest” position of the pedal, in which the lid is closed, while the second position may be an actuated position achieved by a user applying a downward force on the first end of the pedal with his foot, in which the lid is opened. In other embodiments, the waste receptacle 100 is configured to receive a removable lid.

Dollies and anchors for transporting and securing waste receptacles will be described in further details below.

Waste Receptacle Dollies

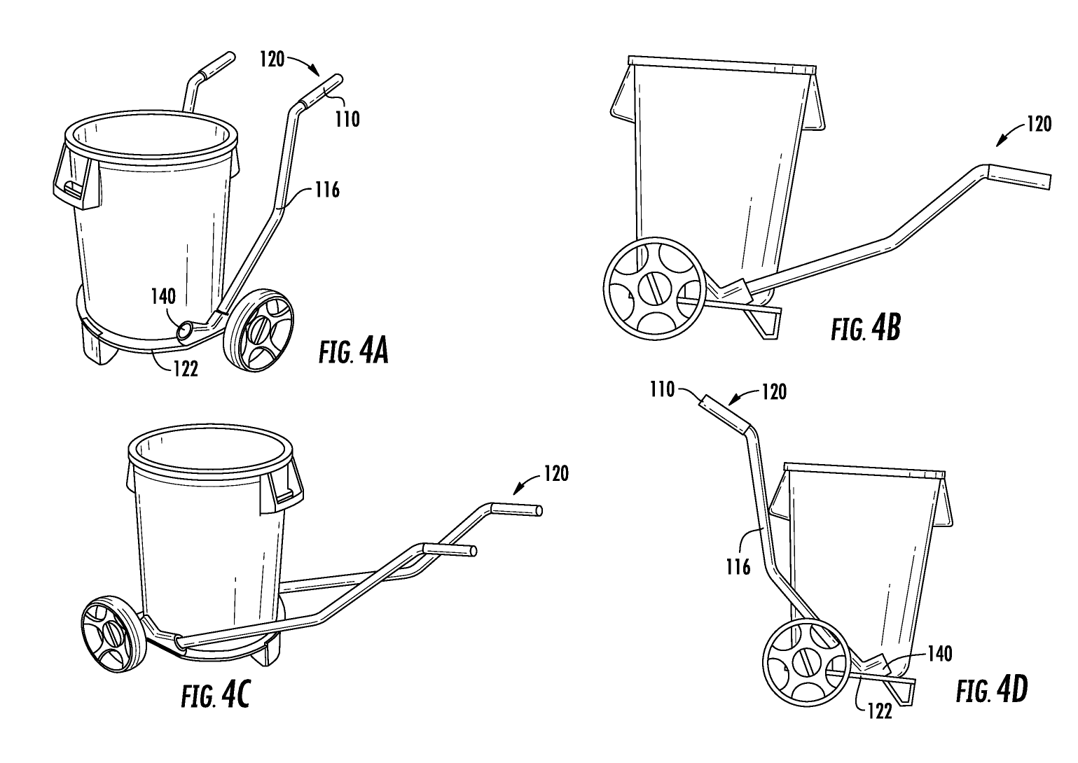

In certain embodiments, as shown in FIG. 2, a dolly 120 for a waste receptacle 100 includes a dolly base 122 configured to securely receive the enclosed base portion 52 of the waste receptacle 100. The waste receptacle 100 includes at least one sidewall 58 extending from the enclosed base portion 52 to define an open top portion 105 configured to receive waste material therethrough, the open top portion 105 being defined by a rim 54. For example, the rim 54 may be integral with or coupled to the sidewall(s) 58 of the waste receptacle 100. For example, the dolly base 122 may include a platform configured to support at least a portion of the enclosed base portion 52 of the waste receptacle 100. For example, the dolly base 122 may have any suitable size and shape. For example, the dolly base may be formed from any suitable material having the desired strength and durability, such as metals and plastics, including structural foams, such as high density polyethylene (HDPE).

In certain embodiments, as shown in FIG. 3, at least two wheels 112 are coupled to the dolly base 122. As used herein, the term “coupled” is used broadly and refers to components being directly or indirectly in contact with one another via any suitable fastening, connection, or attachment mechanism. In certain embodiments, the wheels may attach to a horizontal axle 114. In certain embodiments, the horizontal axle 114 is perpendicularly attached to the elongated shaft(s) 116 and may attach to the dolly base 122.

In certain embodiments, as shown in FIGS. 2 and 4A-4D, at least one elongated shaft 116 is coupled to the dolly base 122 and extends in a direction substantially transverse to the dolly base 122. As used herein, the term “substantially transverse,” when used with reference to the direction of extension of the elongated shaft 116 from the dolly base 122, refers to the elongated shaft(s) 116 being disposed at an angle of from about 60 degrees to about 120 degrees, relative to a plane in which the dolly base 122 is disposed. For example, the elongated shaft(s) 116 may be disposed at an angle of from about 80 degrees to about 100 degrees, relative to a plane in which the dolly base 122 is disposed. In certain embodiments, the elongated shaft(s) 116 are disposed at an angle of about 90 degrees, relative to a plane in which the dolly base 122 is disposed.

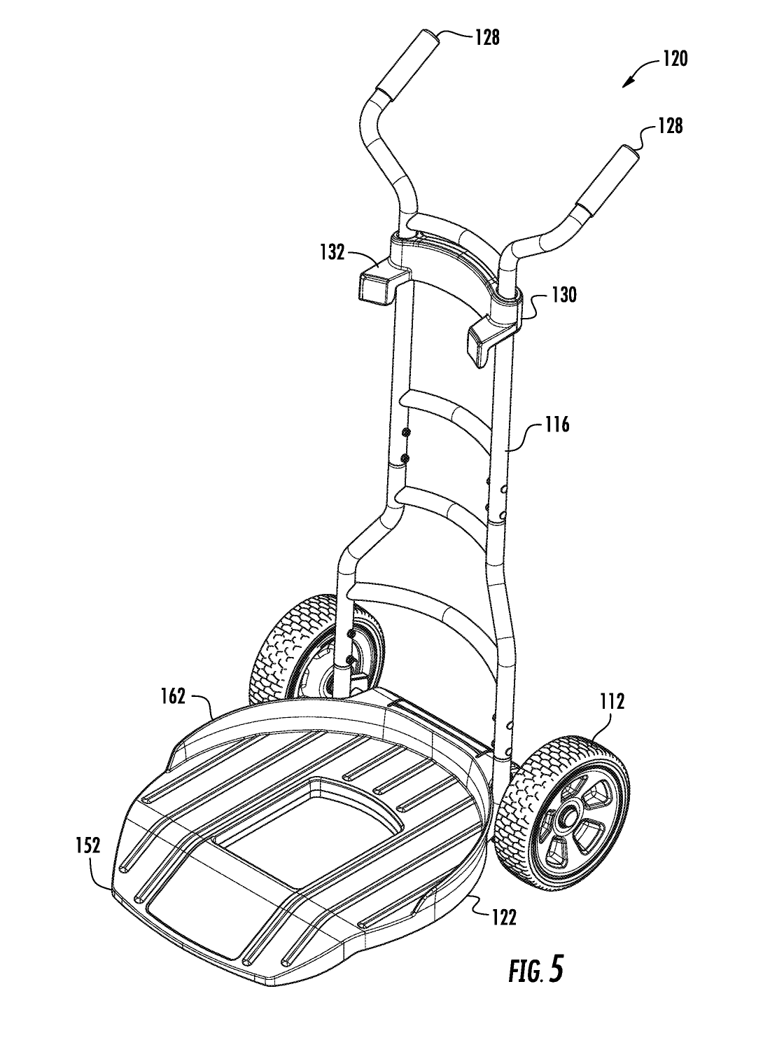

In certain embodiments, as shown in FIG. 5, the dolly 120 includes two elongated shafts 116 that are substantially parallel to one another.

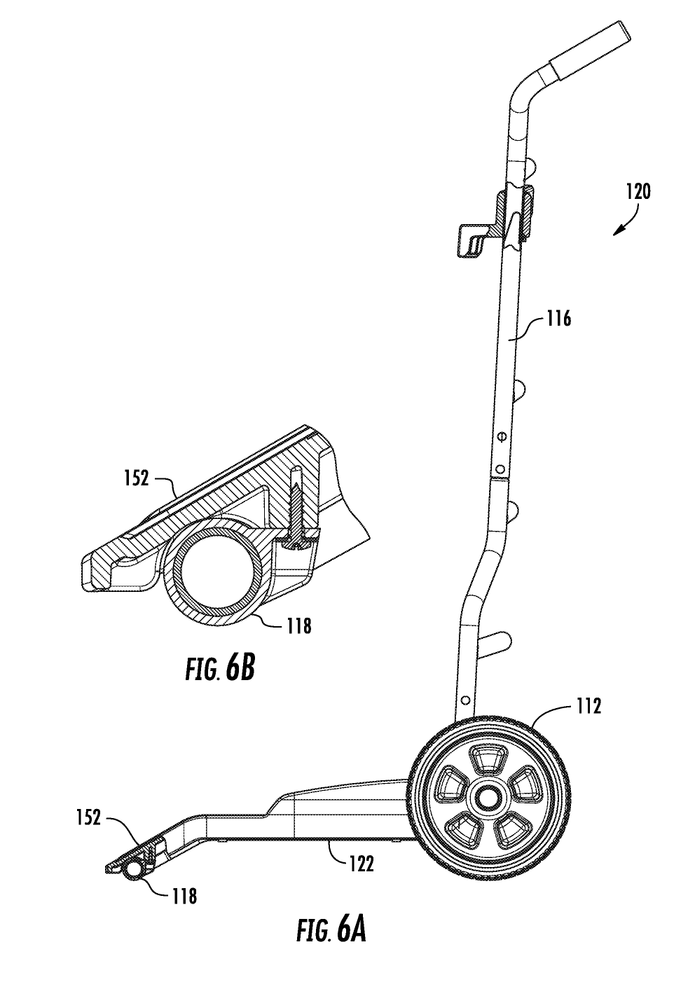

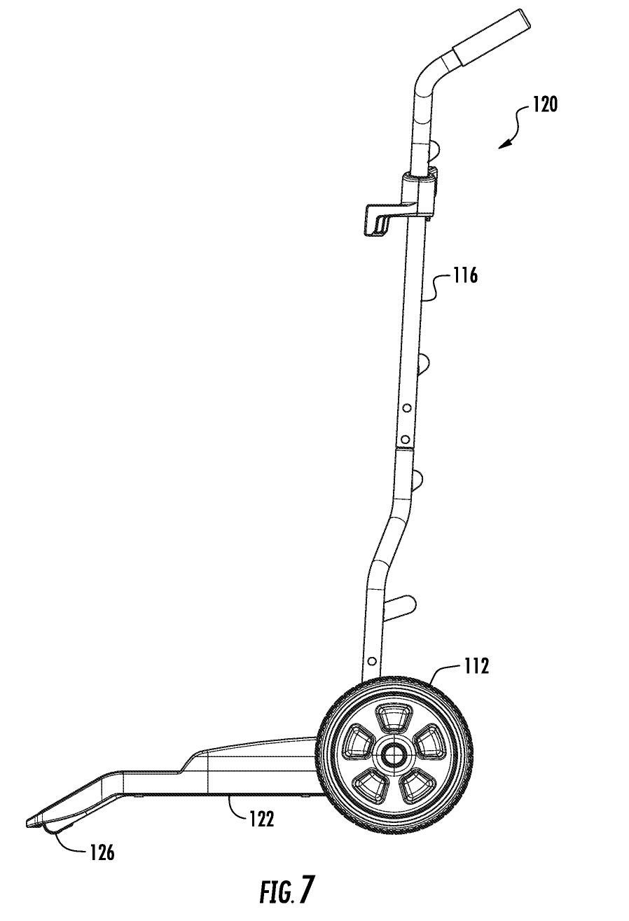

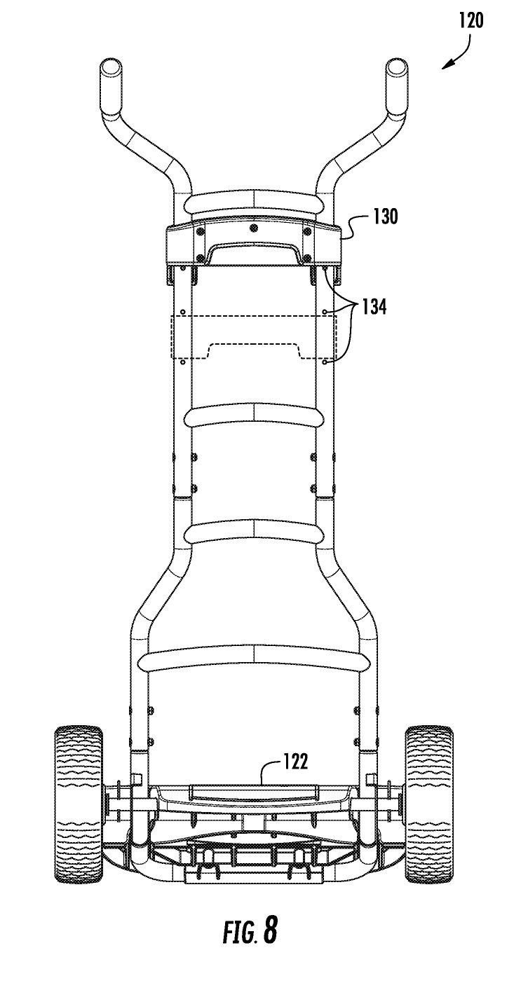

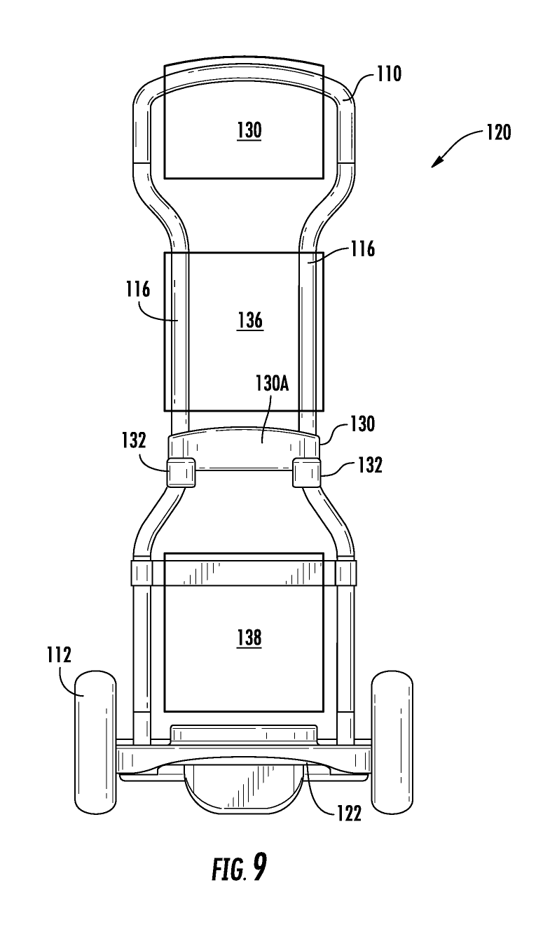

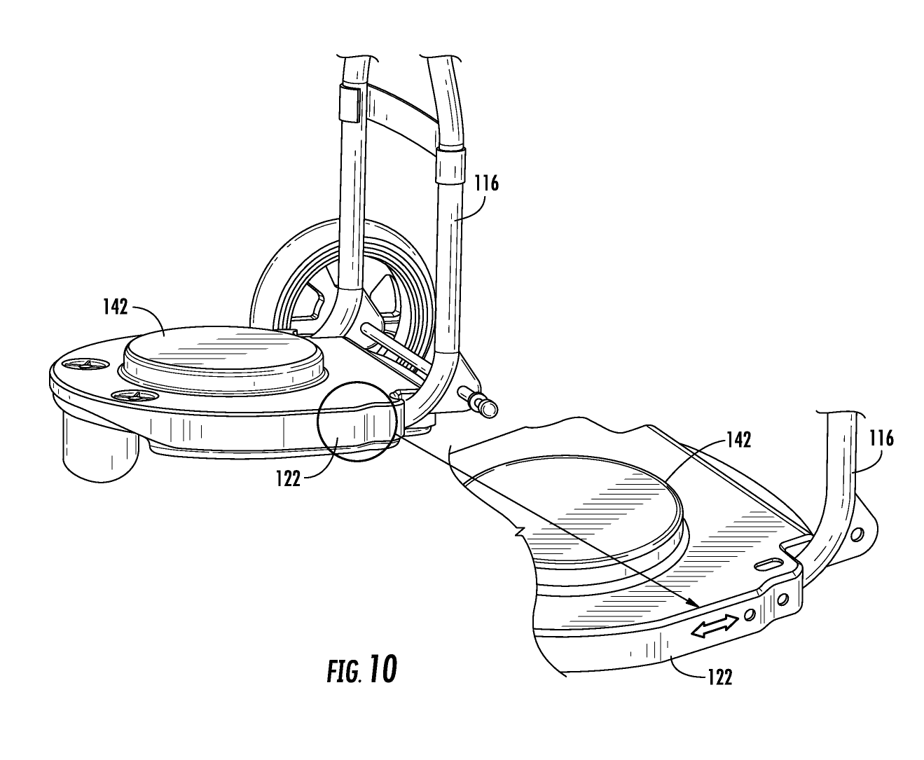

For example, as shown in FIGS. 5-7, the wheels 112 may be coupled to the dolly base 122 via a wheel axle 114 extending between the two wheels 112 and that is coupled to the elongated shafts 116, which are coupled to the dolly base 122. In certain embodiments, the dolly 120 includes two wheels 112. In other embodiments, the dolly 120 includes three or more wheels 112. In one embodiment, as shown in FIGS. 6A-6B, the dolly 120 includes two wheels 112 adjacent the elongated shafts 116 of the dolly 120 and at least one caster 118 coupled to the dolly base 122 opposite the two wheels 112. In some embodiments, as shown in FIG. 6, the caster wheels 118 are embedded under a ramp 152, which is described in greater detail below. In another embodiment, as shown in FIG. 7, the dolly 120 includes at least one stop member 126 coupled to the dolly base 122 and configured to maintain the dolly base 122 substantially level when the dolly 120 is in its standing position (i.e., when it is not tilted for transport).

In certain embodiments, as shown in FIG. 2, at least one handle 128 is coupled to the elongated shaft(s) 116. For example, the handle(s) 128 may be formed in a variety of suitable shapes and designs. In certain embodiments, as shown in FIG. 2, a single handle 128 extends between the two elongated shafts 116. In other embodiments, as shown in FIG. 5, each elongated shaft 116 may have a handle 128 coupled thereto. For example, the handle(s) 128 may be disposed in a plane that is parallel or transverse the plane in which the elongated shaft(s) 116 are disposed.

In certain example embodiments, as shown in FIGS. 5-9, the dolly 120 includes at least one retention member 130 coupled to the at least one elongated shaft 116 and configured to retain the waste receptacle 100 in place on the dolly base 122. For example, the retention member 130 may include a hook portion 132 configured to overhang the rim 124 of the waste receptacle 100 and to retain the waste receptacle 100. That is, the retention member(s) 130 may be configured to extend at least partially into the open top portion 108 of the waste receptacle 100 configured to receive waste material therethrough, such that the waste receptacle 100 is retained between the overhang of the hook portion 132 of the retention member 130 and the elongated shaft(s) 116 of the dolly 120.

In certain embodiments, the at least one retention member 130 is slidable along the at least one elongated shaft 116. For example, the retention member 130 may have an aperture that is configured to receive the elongated shaft 116 therethrough. In one embodiment, as shown in FIG. 8, the retention member(s) 130 are positionable at different heights along the elongated shaft(s) 116 of the dolly 120. For example, the various positions may be defined as positions in which the retention member rests upon one or more push-pins 134 (i.e., selectively retractable pins that are retractable within the elongated member to allow the retention member to slide past and are extendable into a support position in which they support the retention member). For example, the push-pins 134 may engage with the elongated shaft(s) 116. For example, the retention member(s) 130 may be positionable at a position spaced away from the dolly base 122 along the elongated shaft(s) 116. As seen in FIG. 8, the retention member(s) 130 may also be positioned at a lower position (i.e., closer the dolly base) along the elongated shaft(s) 116 where the hook portion 132 rests on top of the rim 124 of the waste receptacle 100. For example, such positions of the push-pins may be provided to accommodate waste receptacles of differing sizes, such that the retention member 130 is positionable in various positions to retain waste receptacles of differing heights.

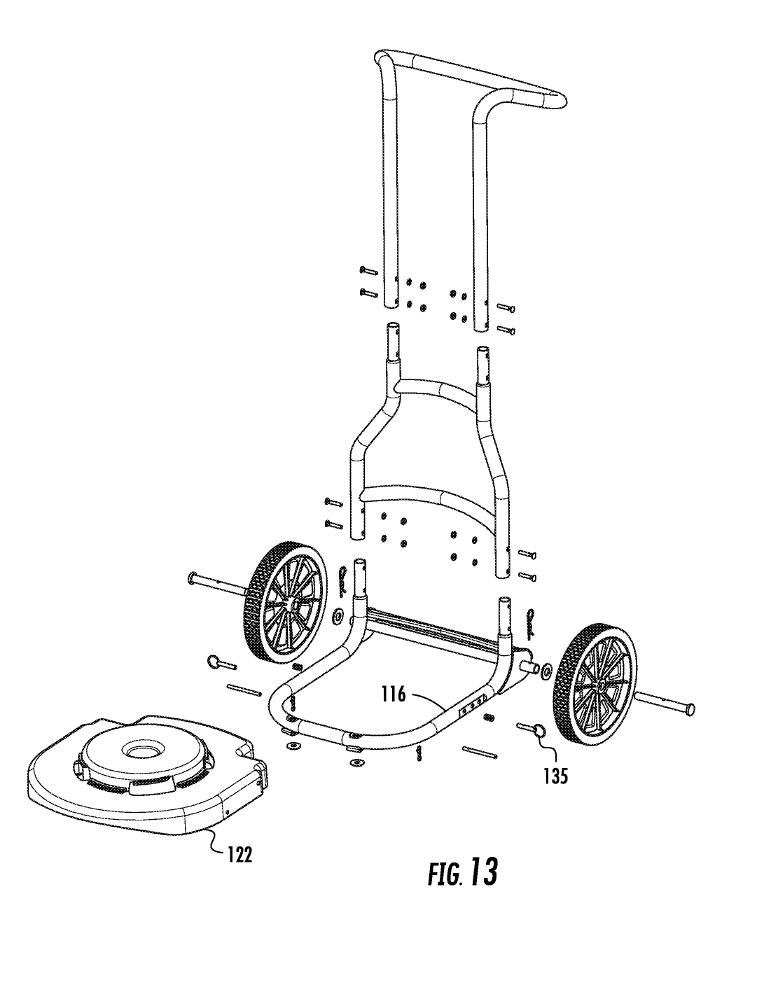

In certain embodiments, as shown in FIGS. 4A-4D and 12-13, the dolly 120 does not have a retention member 130 coupled to the elongated shaft(s) 116 to secure the waste receptacle 100. For example, as shown in FIG. 12, the dolly base 122 may secure a corresponding groove(s) 144 of the waste receptacle 100 to the projection 142, sidewall projection 146, and/or insertion points 148 of the dolly base 122, as will be described in greater detail below. That is, the dolly base 122 may be configured to provide a secure, locking engagement between the base of a waste receptacle and the dolly base through various twist and lock, threaded, or other mating connection mechanisms.

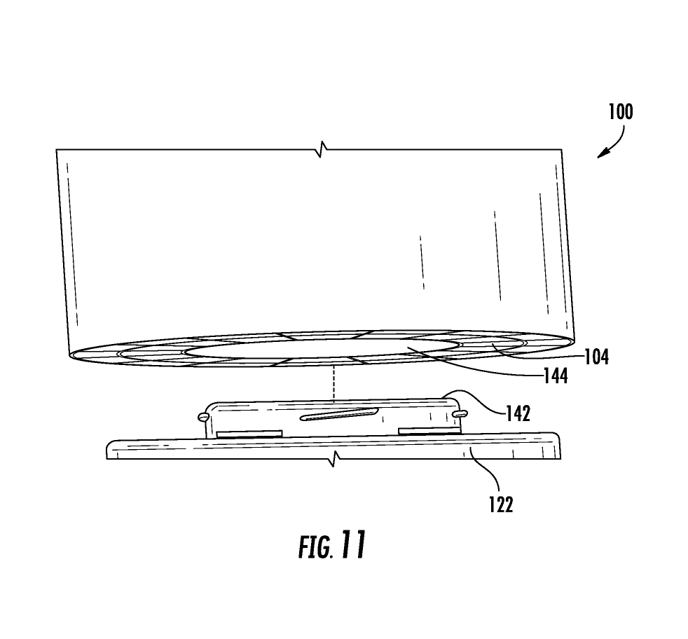

In certain example embodiments, as shown in FIG. 9, the dolly 120 includes elongated shafts 116 coupled to the dolly base 122 and extending in a direction substantially transverse to the dolly base 122, wherein the at least one retention member 130 includes a body portion 130A that extends between the two shafts 116 and two apertures that receive the two elongated shafts 116. For example, as shown in FIG. 9, at a first region 136, the two elongated shafts 116 may be laterally spaced from one another at a first distance that is configured such that the at least one retention member 130 is slidable along the two elongated shafts 116 over the first region 136, and at one or more second regions 138, the two elongated shafts 116 may be laterally spaced from one another at a distance that is greater than the first distance. That is, the retention member 130 may only be able to slide along the elongated shafts 116 in the first region 136. For example, the at least one retention member 130 may include two hook portions 132 spaced from one another and configured to overhang the rim 124 of the waste receptacle 100 and to retain the waste receptacle 100. For example, the hook portions 132 may be spaced from one another by at least about 1 inch.

In certain embodiments, as shown in FIGS. 4A-4D, the dolly 120 inc1udes at least one dual-position mount 140 coupled to the dolly base 122 and configured to receive an end of the at least one elongated shaft 116 opposite the handle 128. For example, the dual-position mount 140 may have two positions in which the end of the elongated shaft 116 is mountable, wherein a first of the two positions is such that the at least one elongated shaft 116 extends in a direction substantially transverse to the dolly base 122 (as shown in FIGS. 4A and 4D), and a second of the two positions is such that the at least one elongated shaft 116 extends at an angle of from about 0 degrees to about 75 degrees, relative to a plane in which the dolly base 122 is disposed (as shown in FIGS. 4B and 4C). That is, in the first position, the elongated shaft(s) 116 and handle(s) 128 may be in a dolly position, while, in the second position, the elongated shaft(s) 116 and handle(s) 128 may be in a wheelbarrow position, allowing for distinct handling of the dolly 120.

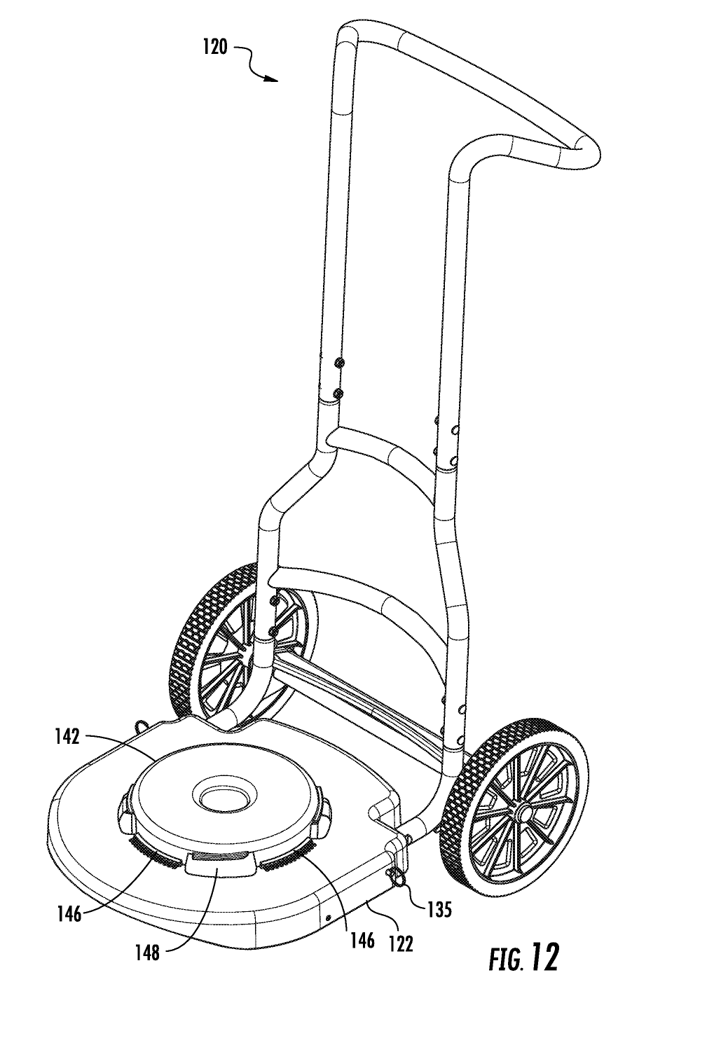

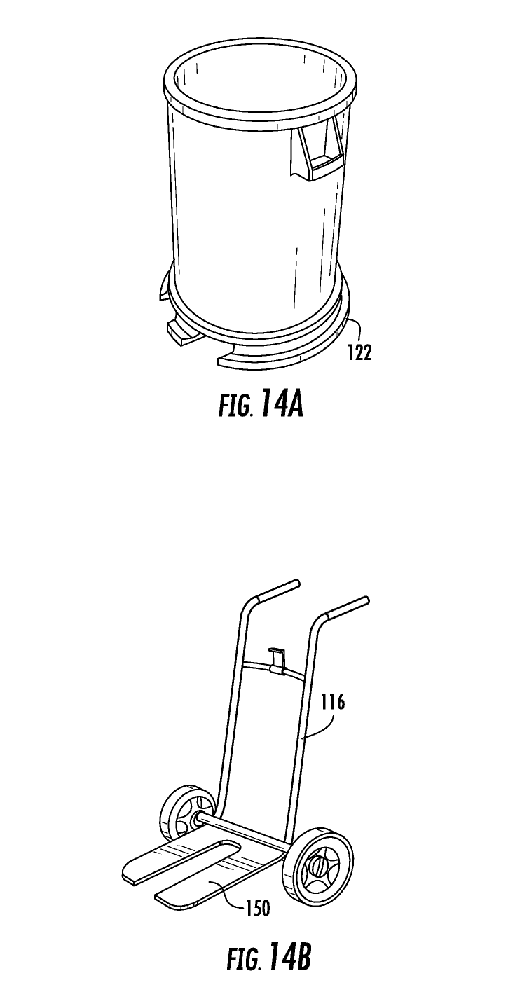

In certain embodiments, as shown in FIGS. 10-12, the dolly base 122 is movable relative to the at least one elongated shaft 116 to accommodate waste receptacles of various dimensions. For example, the dolly base 122 may include one or more adjustable base pins (see 135 in FIGS. 12-13) that can be pulled to slide the base 122 forward to accommodate a waste receptacle 100 having a different sized base enclosed base portion 104.

In certain embodiments, as shown in FIGS. 10-12, the dolly base 122 includes a projection 142 configured to mate with a corresponding groove 144 of the enclosed base portion 104 of the waste receptacle 100. For example, the projection 142 may be threaded such that the enclosed base portion 104 of the waste receptacle 100 is screwable onto the dolly base 122. For example, as shown in FIG. 12, a user may position the waste receptacle 100 having the corresponding groove structure 144 over the projection 142 of the dolly base 122 and twist the waste receptacle 100 to secure, or lock, the waste receptacle 100 in place on the dolly base 122. In one embodiment, as shown in FIG. 12, the projection 142 has a number of equally spaced sidewall projections 146. Between each projection 146 is an insertion point 148 for securing or locking the waste receptacle 100 corresponding groove structure 144. The projection 142 may secure a 10-, 20-, 32-, 44-, or 55-gallon waste receptacle 100.

In certain embodiments, as shown in FIGS. 12 and 13, the dolly base 122 adjusts along the elongated shaft(s) 116. For example, a base pin 135 may be inserted through the dolly base 122 into the elongated shaft(s) 116. The base pin 135 may be formed from any suitable material having the desired strength and durability, such as metals and plastics. In certain embodiments, the dolly base 122 is supported and secured by flat plates, Bellville washers, or other hardware to the elongated shaft(s) 16.

In certain embodiments, the dolly 120 is configured to support at least 250 pounds.

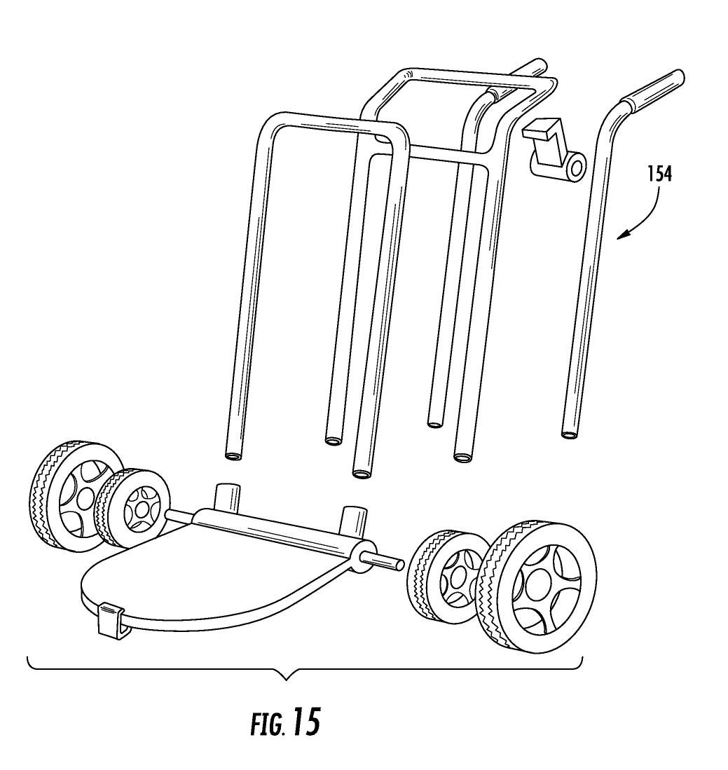

In certain example embodiments, as illustrated in FIGS. 14A and 14B, the dolly base 122 is demountable from the elongated shaft(s) 116. For example, one or more forklift-type prongs 150 may be coupled to the elongated shaft(s) 116, such as via the wheel axle 114, and configured to mate with corresponding channels in the dolly base 122.

In certain embodiments, as shown in FIG. 5, the dolly base 122 includes a ramp 152 for easy loading of a waste receptacle onto the dolly base 122. For example, the dolly base 122 may have a semi-circular lip 162 protruding along the edge of the dolly base 122. The lip may be sized and shaped to snuggly receive a base of a waste receptacle and to secure the waste receptacle on the dolly base 122. That is, the dolly base 122 may be configured to securely receive an enclosed base portion of a waste receptacle via the lip partially encircling the dolly base, to retain a base portion of a waste receptacle therein.

In certain embodiments, the dolly base 122 may extend over horizontal axle 114 in a direction opposite the waste receptacle receiving portion of the base, as shown in FIG. 5. For example, this extension portion may be formed of a structural foam material, such as high density polyethylene (HDPE). For example, this extension portion may form a kick plate or other surface on which a user can position his/her foot to maneuver the dolly.

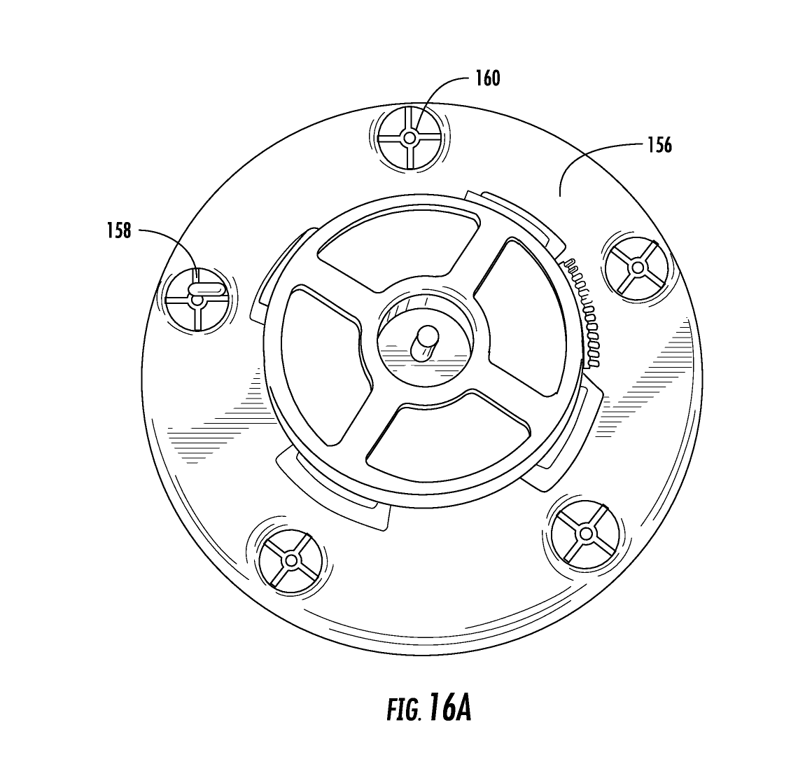

As shown in FIG. 15, the dolly may be a modular dolly 154, in which multiple shaft and wheel options are provided that allow the consumer to select and configure the desired combination of the shaft, wheel, and other dolly features described herein.

Such dollies may be used to maneuver and transport waste receptacles over a variety of terrains and conditions. For example, a user may tilt the dolly onto its larger/back wheels using the handle(s) and push or pull the dolly via its handles to transport it across a surface. The dolly may be pivoted off its back wheels and set down onto its stop, casters, etc. to maintain it at rest.

Waste Receptacle Anchors

Anchors for securing waste receptacles are also provided herein. For example, these anchors may allow for securing a waste receptacle to a variety of surfaces, including soil, grass, sand, gravel, and concrete.

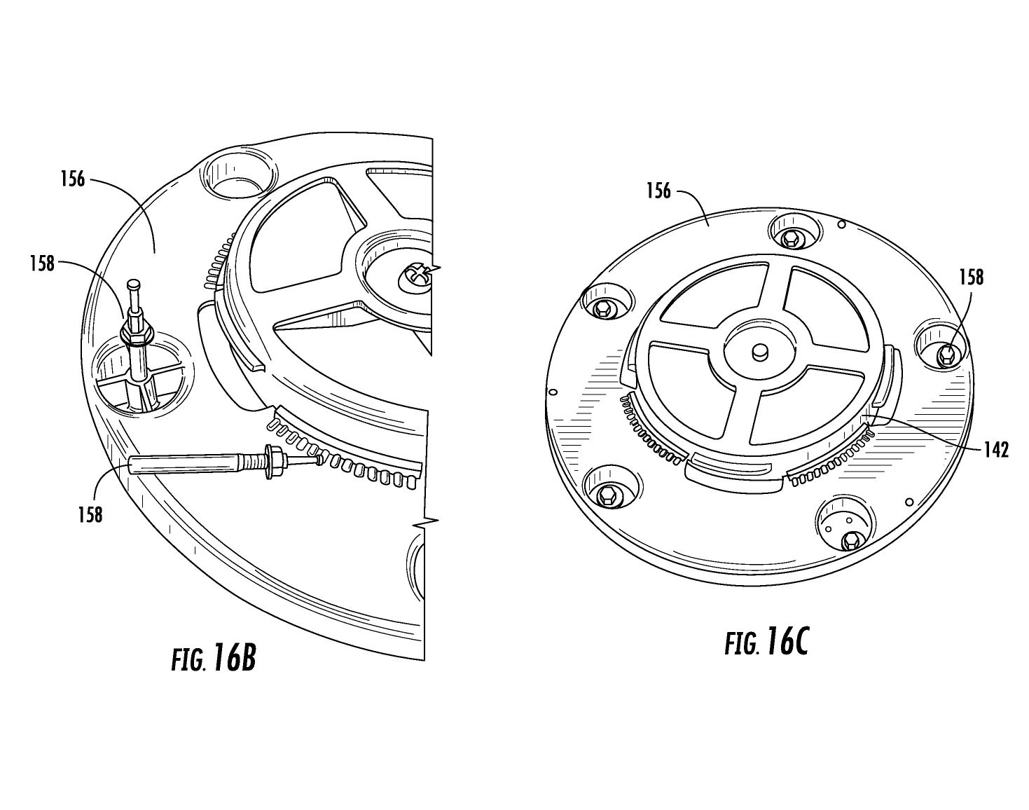

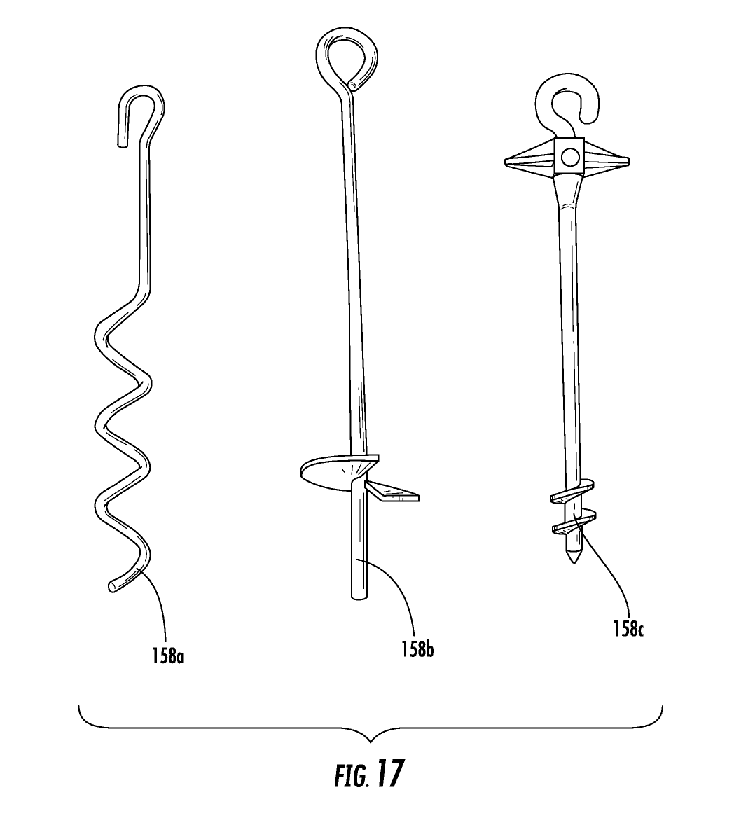

In certain example embodiments, as shown in FIGS. 16A-16C, an anchor for a waste receptacle 100 includes an anchor base 156 configured to securely receive the enclosed base portion 104 of a waste receptacle 100 and that contains at least one aperture 160 configured to securely receive an anchor pin 158 therethrough.

In certain embodiments, as shown in FIGS. 11 and 16A-16C, the anchor base 156 includes a projection 142 configured to mate with a corresponding groove 144 of the enclosed base portion 104 of the waste receptacle 100. For example, the projection 142 may be threaded such that the enclosed base portion 104 of the waste receptacle 100 is screwable onto the anchor base 156. For example, a user may position the waste receptacle 100 having the corresponding groove structure 144 over the projection 142 of the anchor base 156 and twist the waste receptacle 100 to secure, or lock, the waste receptacle 100 in place on the anchor base 156. In other embodiments, other mating connection mechanisms may be used to secure a waste receptacle onto the anchor base.

For example, as shown in FIGS. 16A-16C, the aperture(s) 160 of the anchor base 156 may include any suitable means for coupling the anchor pin 158 to the anchor base 156 and retaining the anchor pin 158 in the aperture(s) 160. For example, the aperture 160 may include a channel that is spaced from the edge of the aperture 160 and connected thereto by one or more ribs.

For example, the anchor base 156 may be formed from any suitable material having the desired strength and durability, such as metals and plastics, including structural foams, such as high density polyethylene (HDPE).

In certain embodiments, as shown in FIG. 17, the anchor pin 158 has an auger 158b, screw 158c, or spiral 158a type configuration. In other embodiments, the anchor pin 158 has a spike configuration. For example, the type of anchor pin 158 used may be selected by the user based on the nature of the surface to which the waste receptacle is being anchored. For example, a spiral anchor 158a, such as a steel spiral anchor, may be suitable for dirt, grass, rock, gravel, and sand surfaces. For example, commercially available concrete anchors (such as shown in FIG. 16B), such as a ⅜″ concrete anchor, may be suitable for concrete surfaces. For example, an auger type configuration 158B, such as a steel or plastic auger, may be suitable for certain surfaces. For example, a spike, such as a steel spike (e.g., a 12″ steel spike), may be suitable for certain surfaces.

In certain embodiments, as shown in FIG. 16A, a plurality of apertures 160 are provided about the perimeter of the anchor base 156, such that the desired number and configuration of anchor pins 158 may be installed by the user. For example, it may be sufficient for certain applications to install three anchor pins 158 about the anchor base 156.

Such anchors may be used to secure a waste receptacle 100 to a variety of surfaces, such that it can withstand forces associated with rough use and/or extreme weather.

Methods for using the dollies and anchors described herein are also contemplated, as are assemblies of the dollies and anchors with a waste receptacle, in accordance with the disclosure herein.

Thus, the present disclosure provides accessories for transporting and securing waste receptacles in outdoor and other high volume environments (e.g., industrial applications, construction applications, food service applications), as well as in situations where terrain is uneven and/or conditions are unstable (e.g., extreme weather conditions). For example, these accessories may be used to traverse and secure waste receptacles across various surfaces and terrains, including but not limited to dirt, gravel, grass, asphalt/pavement, carpet, curbs, inclines/declines, and thresholds.

While the disclosure has been described with reference to a number of embodiments, it will be understood by those skilled in the art that the disclosure is not limited to such disclosed embodiments. Rather, the disclosed embodiments can be modified to incorporate any number of variations, alterations, substitutions, or equivalent arrangements not described herein, but which are commensurate with the scope of the disclosure.

What is claimed is:

1. A dolly for a waste receptacle, comprising:
a dolly base configured to securely receive an enclosed base portion of a waste receptacle that comprises at least one sidewall extending from the enclosed base portion to define an open top portion configured to receive waste material therethrough, the open top portion being defined by a rim;
at least two wheels coupled to the dolly base;
at least one elongated shaft coupled to the dolly base and extending in a direction substantially transverse to the dolly base; and
at least one handle coupled to the shaft.

2. The dolly of claim 1, further comprising at least one retention member coupled to the at least one elongated shaft and configured to retain the waste receptacle.

3. The dolly of claim 2, wherein the at least one retention member comprises a hook portion configured to overhang the rim of the waste receptacle and to retain the waste receptacle.

4. The dolly of claim 2, wherein the at least one retention member is slidable along the at least one elongated shaft.

5. The dolly of claim 1, wherein the dolly base comprises of a ramp opposite the at least two wheels coupled to the dolly base.

6. The dolly of claim 2, comprising two of the at least one elongated shafts coupled to the dolly base and extending in a direction substantially transverse to the dolly base, wherein the at least one retention member comprises a body portion that extends between the two shafts and two apertures that receive the two elongated shafts.

7. The dolly of claim 6, wherein:
at a first region, the two shafts are laterally spaced from one another at a first distance, the first distance being configured such that the at least one retention member is slidable long the two elongated shafts over the first region, and
at a second region, the two shafts are laterally spaced from one another at a distance that is greater than the first distance.

8. The dolly of claim 3, wherein the at least one retention member comprises two hook portions spaced from one another and configured to overhang the rim of the waste receptacle and to retain the waste receptacle.

9. The dolly of claim 1, further comprising at least one caster coupled to the dolly base.

10. The dolly of claim 1, further comprising at least one stop member coupled to the dolly base.

11. The dolly of claim 1, further comprising at least one dual-position mount coupled to the dolly base and configured to receive an end of the at least one elongated shaft opposite the handle, the dual-position mount having two positions in which the end of the elongated shaft is mountable,
wherein a first of the two positions is such that the at least one elongated shaft extends in a direction substantially transverse to the dolly base and a second of the two positions is such that the at least one elongated shaft extends at an angle of from about 0 degrees to about 75 degrees, relative to a plane in which the dolly base is disposed.

12. The dolly of claim 1, wherein the dolly base is movable relative the at least one elongated shaft to accommodate waste receptacles of various dimensions.

13. The dolly of claim 1, wherein the dolly base comprises structural foam.

14. The dolly of claim 1, wherein the dolly base comprises a projection configured to mate with a corresponding groove of the enclosed base portion of the waste receptacle.

15. The dolly of claim 14, wherein the projection is threaded such that the enclosed base portion of the waste receptacle is screwable onto the dolly base.

16. The dolly of claim 1, wherein the dolly base comprises a semi-circular lip protruding along an edge of the dolly base, the semi-circular lip being sized and shaped to securely receive an enclosed base portion of a waste receptacle.

17. An anchor for a waste receptacle, comprising:
an anchor base configured to securely receive an enclosed base portion of a waste receptacle that comprises at least one sidewall extending from the enclosed base portion to define an open top portion configured to receive waste material therethrough, the anchor base comprising at least one aperture configured to securely receive an anchor pin therethrough; and
at least one projection extending from the anchor base and configured to mate with a corresponding groove of the enclosed base portion of the waste receptacle, such that the waste receptacle is secured thereto.

18. The anchor of claim 17, wherein the anchor pin comprises an auger, spiral anchor, or screw.

19. The anchor of claim 17, wherein the anchor base comprises structural foam.

20. The anchor of claim 17, wherein the projection is threaded such that the enclosed base portion of the waste receptacle is screwable onto the anchor base.
